(19) United States
(12) Patent Application Publication
(10) Pub. No.: US 2026/0328908 A1
(43) Pub. Date: Oct. 22, 2026

(54) LIDAR

(71) Applicant: SUTENG INNOVATION TECHNOLOGY CO., LTD., Shenzhen (CN)

(72) Inventor: Binglin LIU, Shenzhen (CN)

(73) Assignee: SUTENG INNOVATION TECHNOLOGY CO., LTD., Shenzhen (CN)

(21) Appl. No.: 19/646,576

(22) Filed: Apr. 14, 2026

(30) Foreign Application Priority Data
Apr. 19, 2025 (CN) 202510497773.3
Apr. 19, 2025 (CN) 202510500330.5

(51) Int. Cl. G01S 7/481; G01S 17/89

(52) U.S. Cl. CPC G01S 7/4813; G01S 17/89

(57) ABSTRACT

The present application discloses a LiDAR comprising a housing, a window cover, and a transceiver module. The housing includes a first bottom wall, a side wall, and a second bottom wall arranged sequentially along a thickness direction of the LiDAR, wherein the first bottom wall, the second bottom wall, and the side wall together define an accommodating cavity, and a window is disposed on the side wall. The window cover is mounted on the housing and covers the window. The housing further includes at least one partition wall, one end of the partition wall being fixed to the first bottom wall and the other end extending toward the second bottom wall. The partition wall divides the accommodating cavity into a first cavity and a second cavity. The transceiver module is disposed in the first cavity, and the second cavity is in communication with the window.

### CROSS-REFERENCE TO RELATED APPLICATIONS

The present application claims the benefit of priority to Chinese Patent Applications No. 202510500330.5 and No. 202510497773.3, both filed on Apr. 19, 2025, which are hereby incorporated by references in their entirety.

### TECHNICAL FIELD

The present application relates to the technical field of LiDAR, and in particular to a LiDAR.

### BACKGROUND

A LiDAR device obtains information about a target by emitting a detection signal toward the target, receiving a signal reflected back from the target, comparing the received signal with the emitted detection signal, and performing appropriate processing. LiDAR devices are capable of precisely measuring the position, motion state, and shape of a target, and of detecting, identifying, discriminating, and tracking targets. Due to their advantages of high measurement speed, high precision, and long detection range, LiDAR devices have been widely applied in fields such as intelligent vehicles.

As a precision optomechanical-electrical product, a LiDAR needs to reduce electromagnetic interference to ensure normal operation. In related art, a window through which detection signals and received signals pass must be provided on the LiDAR. The provision of the window compromises the completeness of the electromagnetic shielding of the LiDAR, and interference signals in the external environment can enter the interior of the LiDAR through the window, affecting the normal operation of the LiDAR.

Furthermore, an interface board is provided in the LiDAR for communicating with external devices and for connecting to an external power source. This makes it easy for external interference signals such as static electricity and electromagnetic noise to enter the interior of the LiDAR through the interface board, affecting the normal operation of internal circuits and compromising the integrity of signals in the circuits.

### SUMMARY

Embodiments of the present application provide a LiDAR capable of improving the anti-interference performance of the LiDAR.

In a first aspect, an embodiment of the present application provides a LiDAR comprising:

a housing comprising a first bottom wall, a side wall, and a second bottom wall arranged sequentially along a thickness direction of the LiDAR, wherein the first bottom wall, the second bottom wall, and the side wall together define an accommodating cavity, and the side wall is provided with a window that communicates the accommodating cavity with an external environment;

a window cover mounted on the housing and covering the window; and

a transceiver module accommodated in the accommodating cavity, configured to emit detection light to detect a target object and to receive return light formed by the detection light reflected from the target object, the detection light and the return light passing into and out of the LiDAR through the window,

wherein the housing further includes at least one partition wall, one end of the partition wall being fixed to the first bottom wall and the other end extending toward the second bottom wall, the partition wall dividing the accommodating cavity into a first cavity and a second cavity, the transceiver module being disposed in the first cavity, and the second cavity being in communication with the window.

In one embodiment, the housing is provided with a mounting plane within the accommodating cavity, the mounting plane comprising an end face of the partition wall facing away from the first bottom wall; the LiDAR further comprises a main control circuit board fixed between the mounting plane and the second bottom wall, and the window is disposed between the main control circuit board and the first bottom wall.

In one embodiment, the main control circuit board has a first surface facing the first bottom wall and a second surface facing the second bottom wall; the LiDAR further comprises a first conductive adhesive disposed on the mounting plane, at least a portion of the first conductive adhesive being disposed on the end face of the partition wall facing away from the first bottom wall, the first conductive adhesive surrounding the first cavity; the main control circuit board is provided on the first surface with a first conductive trace corresponding to the first conductive adhesive, the first conductive trace being connected to a ground wire of the main control circuit board, and the first conductive trace being connected to the first conductive adhesive.

In one embodiment, the main control circuit board is provided on the second surface with a control circuit module and a second conductive trace surrounding the control circuit module, the second conductive trace being connected to the ground wire; the LiDAR further comprises a second conductive adhesive disposed between the main control circuit board and the second bottom wall, surrounding the control circuit module, and connected respectively to the second conductive trace and the second bottom wall.

In one embodiment, the side wall comprises a first wall portion and a second wall portion adjacent to each other in a circumferential direction of the LiDAR; the at least one partition wall comprises a plurality of partition walls including a first partition wall and a second partition wall, one end of the first partition wall being connected to the first wall portion and the other end extending away from the first wall portion, one end of the second partition wall being connected to the second wall portion and the other end extending away from the second wall portion, the first wall portion, the second wall portion, the first partition wall, and the second partition wall jointly enclosing the first cavity.

In one embodiment, the transceiver module comprises:

a transmitting module accommodated in the first cavity and configured to emit detection light, the transmitting module being disposed opposite the first partition wall, the first partition wall being provided with a first opening communicating the first cavity with the second cavity, the first opening being configured to allow the detection light to pass therethrough; and

a receiving module accommodated in the first cavity and configured to receive the return light and perform photoelectric conversion, a gap existing between the first partition wall and the second partition wall to form a second opening communicating the first cavity with the second cavity, the second opening being configured to allow the return light to pass therethrough.

In one embodiment, the LiDAR further comprises:

a transmitting optical system disposed in the second cavity and configured to receive detection light exiting through the first opening and to collimate the detection light; and a receiving optical system disposed at the second opening and configured to receive and converge the return light so that the converged return light is directed toward the receiving module.

In one embodiment, the plurality of partition walls further comprises a third partition wall; the third partition wall is disposed in the first cavity between the transmitting module and the receiving module; the third partition wall comprises a first portion and a second portion, the first portion being disposed parallel to an optical axis of the receiving optical system, the receiving optical system being disposed between the second partition wall and the first portion, one end of the second portion being connected to the first portion and the other end extending away from the receiving optical system, the second portion and the first partition wall being disposed on two opposite sides of the transmitting module.

In one embodiment, the receiving optical system comprises: a lens barrel, the lens barrel being a metal member or having a metal layer on an outer surface thereof; the lens barrel being connected respectively to the second partition wall and the first portion; and a receiving lens disposed within the lens barrel.

In one embodiment, the LiDAR further comprises an interface board module disposed in the second cavity and comprising: a substrate disposed between the first bottom wall and the main control circuit board, the substrate being connected to the main control circuit board; and a connector seat disposed on the side wall, connected to the substrate, and extending out of the accommodating cavity, an end of the connector seat facing away from the substrate being provided with a power interface and/or a communication interface.

In one embodiment, the LiDAR further comprises a third conductive adhesive disposed between an end face of the side wall facing away from the first bottom wall and the second bottom wall, the third conductive adhesive being arranged circumferentially around the LiDAR, and connected respectively to the second bottom wall and the side wall.

In one embodiment, an end face of the side wall facing away from the first bottom wall is provided with an annular recessed portion, an end of the second bottom wall facing toward the side wall is provided with an annular protruding portion, the recessed portion and the protruding portion being located on an outer side of the third conductive adhesive, and the protruding portion being embedded in the recessed portion.

In one embodiment, the first bottom wall, the side wall, and the partition wall are integrally formed.

Based on the LiDAR of the embodiments of the present application, by providing at least one partition wall to divide the accommodating cavity within the housing into two cavities, disposing the transceiver module in the first cavity, and arranging the window in communication with the second cavity, the partition wall achieves isolation between the space where the transceiver module is located and the space in communication with the window. Accordingly, after interference signals enter the second cavity through the window, at least a portion thereof is intercepted by the partition wall, which can reduce the electromagnetic interference of such signals on the transceiver module and improve the anti-interference performance of the LiDAR.

In a second aspect, an embodiment of the present application provides a LiDAR comprising:

a housing provided with an accommodating cavity;

a main control circuit board disposed in the accommodating cavity; and

an interface board module comprising a substrate, a first flexible circuit board, and a conductive element, wherein the substrate is provided with a plurality of pins, the first flexible circuit board has a first end and a second end opposite to each other along an extension direction, the first end is connected to each of the pins, the second end is connected to the main control circuit board, the first flexible circuit board is provided with a first grounding window, the conductive element is disposed at the first grounding window to connect with a ground wire of the first flexible circuit board, and the conductive element is electrically connected to the housing.

In one embodiment, the housing comprises a first bottom wall, a side wall, and a second bottom wall arranged sequentially along a thickness direction of the LiDAR, and the first bottom wall, the second bottom wall, and the side wall together define the accommodating cavity; the main control circuit board is disposed opposite the second bottom wall, the main control circuit board having a first surface facing the first bottom wall and a second surface facing the second bottom wall; the second end is disposed on the second surface, and the conductive element is interposed between the second end and the second bottom wall.

In one embodiment, the first end is located between the first surface and the first bottom wall, and the main control circuit board is provided with a through-hole through which the first flexible circuit board passes.

In one embodiment, the side wall is provided with a window communicating the accommodating cavity with an external environment, the LiDAR further comprising: a window cover covering the window; and a transceiver module accommodated in the accommodating cavity and configured to emit detection light to detect a target object and to receive return light formed by the detection light reflected from the target object, the detection light and the return light passing into and out of the LiDAR through the window; wherein the housing further comprises at least one partition wall, one end of the partition wall being fixed to the first bottom wall and the other end extending toward the second bottom wall, the partition wall dividing the accommodating cavity into a first cavity and a second cavity, the transceiver module being disposed in the first cavity, and the second cavity being in communication with the window.

In one embodiment, the housing is provided with a mounting plane within the accommodating cavity, the mounting plane comprising an end face of the partition wall facing away from the first bottom wall; the main control circuit board is fixed between the mounting plane and the second bottom wall.

In one embodiment, the first end is located in the second cavity.

In one embodiment, the housing further comprises a mounting post disposed in the second cavity, one end of the mounting post being fixed to the first bottom wall and the other end extending toward the second bottom wall; the LiDAR further comprises: a heating assembly disposed on the window cover and configured to heat the window cover; and a second flexible circuit board disposed in the second cavity, one end of the second flexible circuit board being electrically connected to the heating assembly, and the other end being provided with a contact terminal; wherein the contact terminal is fixed to an end of the mounting post facing away from the first bottom wall, and the first surface of the main control circuit board is provided with a conductive spring contact that elastically presses against the contact terminal.

In one embodiment, the LiDAR further comprises a first conductive adhesive disposed on the mounting plane, at least a portion of the first conductive adhesive being disposed on the end face of the partition wall facing away from the first bottom wall, the first conductive adhesive surrounding the first cavity; the main control circuit board is provided on the first surface with a first conductive trace corresponding to the first conductive adhesive, the first conductive trace being connected to the ground wire of the main control circuit board, and the first conductive trace being connected to the first conductive adhesive.

In one embodiment, the main control circuit board is provided on the second surface with a control circuit module and a second conductive trace surrounding the control circuit module, the second conductive trace being connected to the ground wire of the main control circuit board; the LiDAR further comprises a second conductive adhesive disposed between the main control circuit board and the second bottom wall, surrounding the control circuit module, and connected respectively to the second conductive trace and the second bottom wall; and the second end is located outside a region surrounded by the second conductive adhesive.

In one embodiment, the control circuit module comprises a main controller, and the main control circuit board is provided on the second surface with a clock circuit connected to the main controller, the clock circuit being configured to generate a clock signal and comprising a crystal oscillator, a clock generator, and a filter connected in sequence, the filter being configured to perform high-frequency harmonic filtering on the clock signal input to the main controller.

In one embodiment, the side wall comprises a first wall portion and a second wall portion adjacent to each other in a circumferential direction of the LiDAR; the at least one partition wall comprises a plurality of partition walls including a first partition wall and a second partition wall, one end of the first partition wall being connected to the first wall portion and the other end extending away from the first wall portion, one end of the second partition wall being connected to the second wall portion and the other end extending away from the second wall portion, the first wall portion, the second wall portion, the first partition wall, and the second partition wall jointly enclosing the first cavity.

In one embodiment, the transceiver module comprises:

a transmitting module accommodated in the first cavity and configured to emit detection light, the transmitting module being disposed opposite the first partition wall, the first partition wall being provided with a first opening communicating the first cavity with the second cavity, the first opening being configured to allow the detection light to pass therethrough; and

a receiving module accommodated in the first cavity and configured to receive the return light and perform photoelectric conversion, a gap existing between the first partition wall and the second partition wall to form a second opening communicating the first cavity with the second cavity, the second opening being configured to allow the return light to pass therethrough.

In one embodiment, the transmitting module comprises a transmitting board and a third flexible circuit board, the third flexible circuit board being connected respectively to the transmitting board and the main control circuit board; the receiving module comprises a receiving board and a fourth flexible circuit board, the fourth flexible circuit board being connected respectively to the receiving board and the main control circuit board; the fourth flexible circuit board is covered on at least the side where signal lines are provided with a shielding film, or the fourth flexible circuit board is sandwiched between two shielding films, and the fourth flexible circuit board is provided with conductive vias electrically connecting the shielding film to a ground wire of the fourth flexible circuit board.

In one embodiment, the LiDAR further comprises:

a transmitting optical system disposed in the second cavity and configured to receive detection light exiting through the first opening and to collimate the detection light; and

a receiving optical system disposed at the second opening and configured to receive and converge the return light so that the converged return light is directed toward the receiving module.

In one embodiment, the plurality of partition walls further comprises a third partition wall; the third partition wall is disposed in the first cavity between the transmitting module and the receiving module; the third partition wall comprises a first portion and a second portion, the first portion being disposed parallel to an optical axis of the receiving optical system, the receiving optical system being disposed between the second partition wall and the first portion, one end of the second portion being connected to the first portion and the other end extending away from the receiving optical system, the second portion and the first partition wall being disposed on two opposite sides of the transmitting module.

Furthermore, by disposing the conductive element at the first grounding window of the first flexible circuit board so that the conductive element directly electrically connects the ground wire of the first flexible circuit board to the housing, a low-impedance grounding path is formed. External interference signals such as static electricity and electromagnetic noise can be rapidly discharged to the housing through the conductive element, preventing such interference signals from entering the main control circuit board, thereby ensuring the signal quality of the main control circuit board and improving the anti-interference performance of the product.

### BRIEF DESCRIPTION OF DRAWINGS

To more clearly illustrate the embodiments of the present application or the technical solutions in the prior art, the drawings are briefly described below. Obviously, the drawings described below are only some embodiments of the present application, and for those of ordinary skill in the art, other drawings may be obtained according to the structures shown in these drawings without creative effort.

FIG. 1 is a structural schematic diagram of a LiDAR according to an embodiment of the present application;

FIG. 2 is an exploded view of a LiDAR according to an embodiment of the present application;

FIG. 3 is a schematic diagram showing the arrangement of partition walls in a LiDAR according to an embodiment of the present application;

FIG. 4 is a top view of a LiDAR according to an embodiment of the present application;

FIG. 5 is a cross-sectional view taken along line A-A of FIG. 4;

FIG. 6 is a partial schematic diagram of region B of FIG. 5;

FIG. 7 is a partial schematic diagram of region C of FIG. 5;

FIG. 8 is a schematic diagram showing the internal structure of a LiDAR according to an embodiment of the present application;

FIG. 9 is a schematic diagram showing the internal structure of a LiDAR according to an embodiment of the present application from another perspective; and

FIG. 10 is a schematic diagram showing the connection structure between the main control board and the transceiver module in a LiDAR according to an embodiment of the present application.

Reference numerals: 10, LiDAR; 100, housing; 110, first bottom wall; 120, side wall; 121, window; 122, first wall portion; 123, second wall portion; 124, recessed portion; 130, second bottom wall; 131, protruding portion; 140, partition wall; 141, first partition wall; 1411, first opening; 142, second partition wall; 143, third partition wall; 1431, first portion; 1432, second portion; 144, second opening; 150, first cavity; 160, second cavity; 200, main control circuit board; 210, through-hole; 220, control circuit module; 300, interface board module; 310, substrate; 311, pin; 320, first flexible circuit board; 321, first end; 322, second end; 330, conductive element; 340, connector seat; 400, window cover; 500, transceiver module; 510, transmitting module; 511, transmitting board; 512, third flexible circuit board; 520, receiving module; 521, receiving board; 522, fourth flexible circuit board; 600, first conductive adhesive; 700, second conductive adhesive; 800, third conductive adhesive; 910, transmitting optical system; 920, receiving optical system; 921, lens barrel.

The realization, functional features, and advantages of the objectives of the present application will be further described with reference to the accompanying drawings in conjunction with the embodiments.

### DETAILED DESCRIPTION

To make the objectives, technical solutions, and advantages of the present application clearer, the following will further describe in detail the embodiments of the present application with reference to the accompanying drawings.

When the following description refers to the drawings, the same numerals in different drawings indicate the same or similar elements unless otherwise indicated. The implementations described in the following exemplary embodiments do not represent all implementations consistent with the present application. Rather, they are merely examples of devices and methods consistent with certain aspects of the present application as detailed in the appended claims.

A LiDAR device obtains information about a target by emitting a detection signal toward the target, receiving a signal reflected back from the target, comparing the received signal with the emitted detection signal, and performing appropriate processing.

In related art, a window is provided on a LiDAR through which detection signals and received signals enter and exit the LiDAR. However, the provision of the window also allows interference signals (such as electromagnetic interference signals) in the external environment to enter the interior of the LiDAR through the window, affecting the normal operation of the internal circuits of the LiDAR.

The present application provides a LiDAR that, by providing a housing including a partition wall, isolates the space connected to the window from the space in which the transceiver module is installed, thereby reducing the risk that interference signals entering the housing through the window affect the normal operation of the transceiver module, and improving the anti-interference performance of the LiDAR.

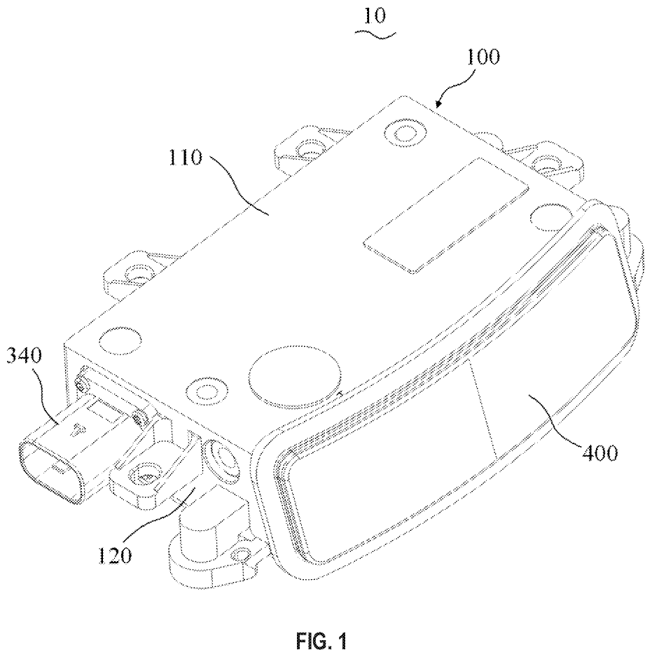

Referring to FIGS. 1-3, in an embodiment, the LiDAR 10 includes a housing 100, a window cover 400, and a transceiver module 500. The housing 100 is provided with an accommodating cavity, and the housing 100 is provided with a window 121 communicating the accommodating cavity with the external environment. The window cover 400 is mounted on the housing 100 and covers the window 121. The transceiver module 500 is accommodated in the accommodating cavity and is configured to emit detection light to detect a target object and to receive return light formed by the detection light reflected from the target object. The detection light and the return light pass into and out of the LiDAR 10 through the window 121.

The housing 100 is used to protect the transceiver module 500 located within the accommodating cavity, maintain the integrity of the LiDAR 10, and extend the service life of the internal components and the overall LiDAR 10. For example, the housing 100 includes a first bottom wall 110, a side wall 120, and a second bottom wall 130 arranged sequentially along a thickness direction of the LiDAR 10, and the first bottom wall 110, the second bottom wall 130, and the side wall 120 together define the accommodating cavity, with the window 121 disposed on the side wall 120. In some embodiments, the housing 100 may also be configured in other forms that provide a complete accommodating cavity, which is not specifically limited herein. In some embodiments, to improve the overall electromagnetic compatibility of the LiDAR 10, the material of the housing 100 includes metal. A metal housing 100 can absorb electromagnetic wave energy and convert it into electrical current, which is then discharged through grounding, thereby blocking external electromagnetic interference from entering the housing 100 and suppressing internal electromagnetic radiation. The housing 100 may be entirely made of metal, including but not limited to copper or aluminum; the housing 100 may also be an insulating member plated with a metal layer, the metal layer being disposed on the inner wall surface of the housing 100, or on both the inner wall surface and outer wall surface of the housing 100; the metal layer includes but is not limited to copper or aluminum, and the insulating member includes but is not limited to plastic or ceramic.

The window cover 400 has the property of allowing laser light to pass through, so that detection light and return light can pass through the window cover 400 into and out of the LiDAR 10. In some embodiments, the window cover 400 includes but is not limited to a transparent glass sheet or a transparent acrylic plate. It will be appreciated that the provision of the window 121 in the housing 100 compromises the shielding performance of the complete housing 100, and external interference signals (such as electromagnetic interference signals) can enter the accommodating cavity through the window 121, thereby affecting the generation of detection light and the reception of return light, and ultimately reducing the accuracy and precision of the resulting point cloud data. Similarly, electromagnetic interference signals generated by the transceiver module 500 may also propagate to the external environment through the window 121, thereby affecting other sensors in the vicinity of the LiDAR, and may also affect other active devices inside the LiDAR 10.

To this end, in some embodiments, the housing 100 further includes at least one partition wall 140. One end of the partition wall 140 is fixed to the first bottom wall 110, and the other end extends toward the second bottom wall 130. The partition wall 140 divides the accommodating cavity into a first cavity 150 and a second cavity 160. The transceiver module 500 is disposed in the first cavity 150, and the second cavity 160 is in communication with the window 121.

By providing at least one partition wall 140, the accommodating cavity is divided into two cavities. The transceiver module 500 is disposed in the first cavity 150, and the window 121 is arranged to communicate with the second cavity 160, so that the partition wall 140 isolates the space where the transceiver module 500 is located from the space connected to the window 121. Accordingly, after interference signals enter the second cavity 160 through the window 121, they are intercepted by the partition wall 140, thereby preventing at least a portion of the interference signals from entering the first cavity 150, avoiding electromagnetic interference of such signals with the transceiver module 500, and improving the anti-interference performance of the LiDAR 10.

It should be noted that the number of partition walls 140 is not limited. In some embodiments, there may be one partition wall 140, which defines the first cavity 150 by connecting to the side wall 120. There may also be a plurality of partition walls 140, which may together define the first cavity 150 or cooperate with the side wall 120 to define the first cavity 150. The partition wall 140 has electromagnetic shielding properties. Specifically, the partition wall 140 may be entirely made of metal, including but not limited to copper or aluminum; the partition wall 140 may also be an insulating member plated with a metal layer, the metal layer being disposed on the outer surface or interior of the partition wall 140; the metal layer includes but is not limited to copper or aluminum, and the insulating member includes but is not limited to plastic or ceramic.

In some embodiments, the LiDAR 10 further includes a main control circuit board 200. The main control circuit board 200 is provided with a control circuit module 220, which includes a main controller. The main controller is configured to send control signals to control the LiDAR 10 to emit detection light and to control the LiDAR 10 to receive return light. The return light is formed by the detection light reflected from the detected object. The main controller is also configured to process the received signals to obtain point cloud data. The main control circuit board 200 is electrically connected to the interface board module 300, through which the main control circuit board 200 communicates with external devices to transmit point cloud data. The main controller includes a hardware chip, which may be implemented by an Application Specific Integrated Circuit (ASIC), a Field Programmable Gate Array (FPGA), or a combination thereof. It will be appreciated that, during operation of the LiDAR 10, ensuring the integrity of control signals on the main control circuit board 200 is essential to guaranteeing the accuracy and precision of the resulting point cloud data. It is also necessary to ensure the integrity of data signals transmitted outward by the main control circuit board 200, so that external devices can ultimately receive complete and accurate point cloud data.

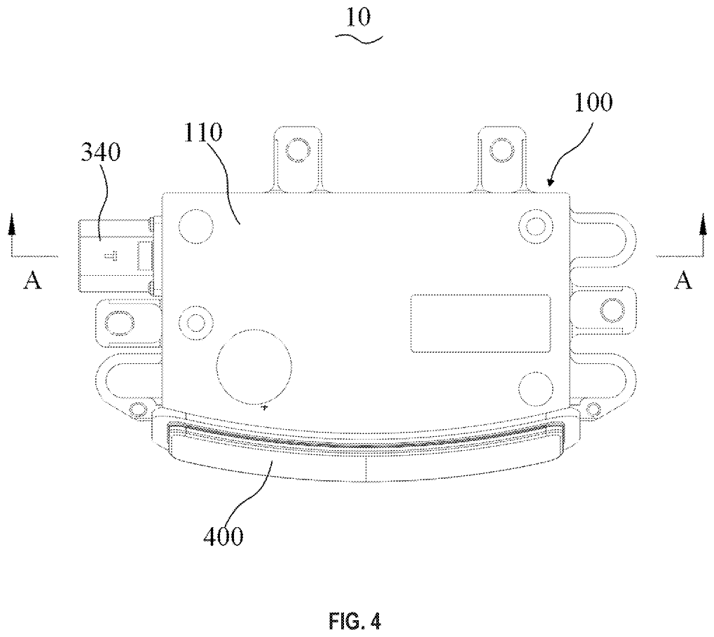

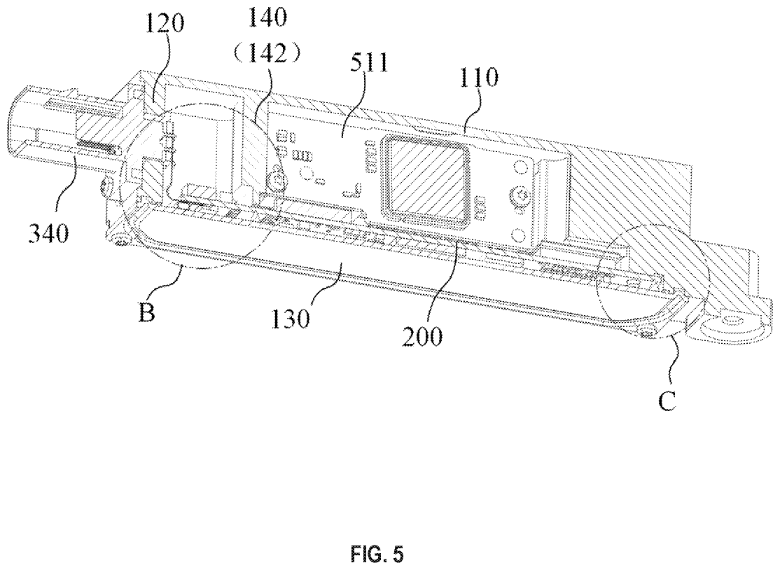

Referring to FIGS. 4-6, in some embodiments, the housing 100 is provided with a mounting plane within the accommodating cavity, the mounting plane including the end face of the partition wall 140 facing away from the first bottom wall 110. The main control circuit board 200 is fixed between the mounting plane and the second bottom wall 130, and the window 121 is disposed between the main control circuit board 200 and the first bottom wall 110.

It will be appreciated that the partition wall 140 serves as a peripheral side wall of the first cavity 150 to define the first cavity 150. When the partition wall 140 is located between the main control circuit board 200 and the first bottom wall 110, the first bottom wall 110 and the main control circuit board 200 serve as the two bottom walls of the first cavity 150, further defining the two ends of the first cavity 150 to be substantially closed, thereby providing complete shielding of the first cavity 150. When the main control circuit board 200 is disposed within either the first cavity 150 or the second cavity 160, the first bottom wall 110 and the second bottom wall 130 serve as the two bottom walls of the first cavity 150 to define the first cavity 150, providing complete shielding of the first cavity 150. The end face of the partition wall 140 facing away from the first bottom wall 110 serves as at least a portion of the mounting plane, which correspondingly indicates that the partition wall 140 is disposed between the first bottom wall 110 and the main control circuit board 200, with the main control circuit board 200 serving as one bottom wall of the first cavity 150. Compared to the arrangement where the main control circuit board 200 is disposed within either the first cavity 150 or the second cavity 160, using the main control circuit board 200 as one bottom wall of the first cavity 150 can ensure that the dimensions of the main control circuit board 200 are as large as possible while satisfying a miniaturized design.

For example, the main control circuit board 200 has a first surface facing the first bottom wall 110 and a second surface facing the second bottom wall 130. The position of the window 121 on the side wall 120 is between the main control circuit board 200 and the first bottom wall 110, preventing interference signals from passing through the window 121 and affecting the normal operation of the electronic components on the second surface. Specifically, the main control circuit board 200 divides the accommodating cavity into a portion located between the first bottom wall 110 and the main control circuit board 200, and another portion located between the second bottom wall 130 and the main control circuit board 200. The partition wall 140 further divides the space between the first bottom wall 110 and the main control circuit board 200 into the first cavity 150 and the second cavity 160. The main control circuit board 200 itself isolates the electronic components on the second surface from the transceiver module 500, thereby achieving electromagnetic shielding between the electronic components on the second surface and the transceiver module 500 and preventing interference signal crosstalk between them.

In some embodiments, the mounting plane not only includes the end face of the partition wall 140 facing away from the first bottom wall 110 described above, but also includes a step surface on the side wall 120 that is coplanar with the end face and disposed along the circumferential direction of the LiDAR 10. The edge of the main control circuit board 200 is connected to the step surface on the side wall 120, improving the stability of the main control circuit board 200 within the housing 100 and preventing the main control circuit board 200 from shaking and affecting the normal operation of the LiDAR 10. Specifically, the main control circuit board 200 is fixedly connected to the mounting plane by means including but not limited to adhesive bonding, snap-fitting, bolt connection, or screw connection.

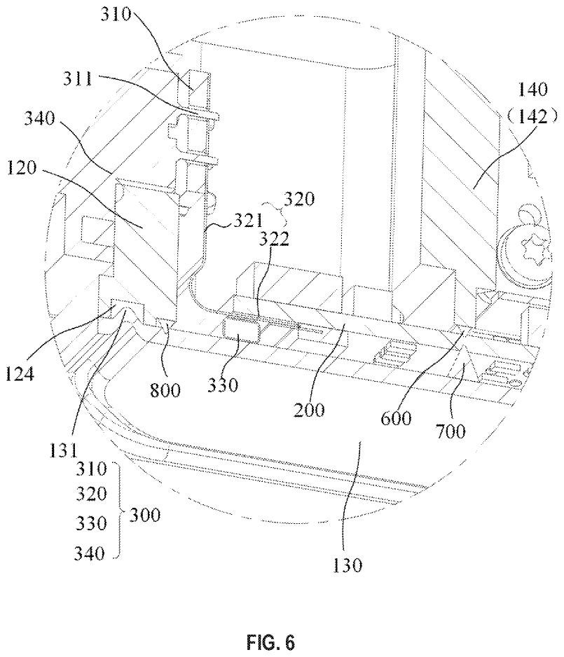

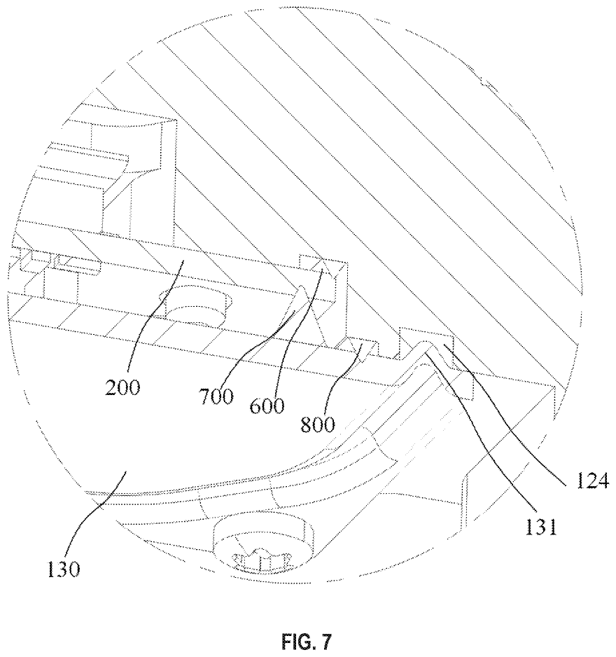

Referring to FIGS. 6-8, in some embodiments, to enhance the shielding effect within the first cavity 150, the LiDAR 10 further includes a first conductive adhesive 600. The first conductive adhesive 600 is disposed on the mounting plane, and at least a portion of the first conductive adhesive 600 is disposed on the end face of the partition wall 140 facing away from the first bottom wall 110. The first conductive adhesive 600 surrounds the first cavity 150. The main control circuit board 200 is provided on the first surface with a first conductive trace corresponding to the first conductive adhesive 600, the first conductive trace being connected to the ground wire of the main control circuit board 200, and the first conductive trace being connected to the first conductive adhesive 600.

It will be appreciated that the mounting plane may also include a step surface on the side wall 120. When the partition wall 140 and the side wall 120 cooperate to serve as the peripheral side walls defining the first cavity 150, a portion of the first conductive adhesive 600 is disposed on the step surface and another portion is disposed on the end face of the partition wall 140 facing away from the first bottom wall 110, so that the first conductive adhesive 600 surrounds the first cavity 150. The mounting plane may also comprise only the end face of the partition wall 140 facing away from the first bottom wall 110, with multiple partition walls 140 cooperating in surrounding fashion to serve as the peripheral side walls defining the first cavity 150, in which case the first conductive adhesive 600 is entirely disposed on the end face of the partition wall 140 facing away from the first bottom wall 110.

Electrical continuity between the ground wire of the main control circuit board 200 and the partition wall 140 is achieved through the first conductive adhesive 600 surrounding the first cavity 150. On one hand, the first conductive adhesive 600 can fill the gap between the end face of the partition wall 140 facing away from the first bottom wall 110 and the first surface of the main control circuit board 200, thus improving the sealing and electromagnetic shielding effectiveness between them. On the other hand, the first conductive adhesive 600 and the first conductive trace provide a low-impedance grounding path for the main control circuit board 200, thus enabling rapid discharge of static electricity or transient noise and improving resistance to pulse interference. At the same time, the conductive adhesive combines conductive and adhesive functions. The first conductive adhesive 600 disposed between the end face of the partition wall 140 facing away from the first bottom wall 110 and the first surface of the main control circuit board 200 serves to secure the main control circuit board 200, reducing displacement of the main control circuit board 200 or poor contact with other components due to vibration.

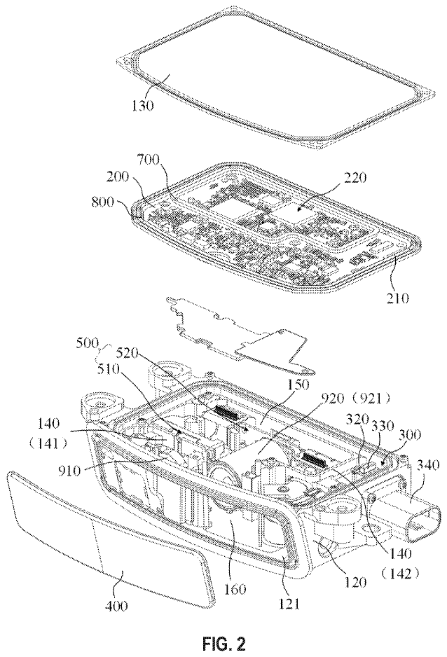

Referring to FIGS. 2, 6, and 7, in some embodiments, the main control circuit board 200 is provided on the second surface with a control circuit module 220 and a second conductive trace surrounding the control circuit module 220. The second conductive trace is connected to the ground wire of the main control circuit board 200. The LiDAR 10 further includes a second conductive adhesive 700 disposed between the main control circuit board 200 and the second bottom wall 130, surrounding the control circuit module 220, and connected respectively to the second conductive trace and the second bottom wall 130.

On one hand, the second conductive adhesive 700 arranged in a surrounding fashion forms a closed annular grounding shielding structure. Together with the second bottom wall 130 and the main control circuit board 200, it defines a shielding cavity that protects the control circuit module 220, thus physically isolating the control circuit module 220 from other electronic components on the main control circuit board 200, and minimizing or preventing signal crosstalk between the control circuit module 220 and the other electronic components on the main control circuit board 200. On the other hand, the second conductive adhesive 700 and the second conductive trace provide the main control circuit board 200 with a low-impedance grounding path, thus enabling rapid discharge of static electricity or transient noise and improving resistance to pulse interference. At the same time, the second conductive adhesive 700 is connected to the second bottom wall 130, providing further securing of the main control circuit board 200. The region surrounded by the second conductive adhesive 700 may also include other high-frequency electronic components. The second conductive adhesive 700 and the second bottom wall 130 shield the electromagnetic signals of the high-frequency electronic components, thereby preventing high-frequency electromagnetic leakage generated by the high-frequency electronic components from affecting other electronic sub-components on the main control circuit board 200.

In some embodiments, the first conductive trace is an exposed copper trace on the first surface of the main control circuit board 200, and the second conductive trace is an exposed copper trace on the second surface of the main control circuit board 200. That is, through a windowing arrangement, the copper material forming the ground wire inside the main control circuit board 200 is exposed, so that the first conductive adhesive 600 can connect the ground wire to the partition wall 140 to achieve a low-impedance connection between the ground wire of the main control circuit board 200 and the partition wall 140, and the second conductive adhesive 700 can connect the ground wire to the second bottom wall 130 to achieve a low-impedance connection between the ground wire of the main control circuit board 200 and the second bottom wall 130. Considering that oxide layers may form on the surfaces of the partition wall 140 and the second bottom wall 130, a laser engraving process may be used to remove the oxide layer from the area of the partition wall 140 that contacts the first conductive adhesive 600, forming a conductive surface to enhance the conductivity after connection between the partition wall 140 and the first conductive adhesive 600 and the electromagnetic shielding effect for the transceiver module 500. Similarly, a laser engraving process may be used to remove the oxide layer from the area of the second bottom wall 130 that contacts the second conductive adhesive 700, forming a conductive surface to enhance the conductivity after connection between the second bottom wall 130 and the second conductive adhesive 700 and the electromagnetic shielding effect for the control circuit module 220.

In some embodiments, the first bottom wall 110, the side wall 120, and the partition wall 140 are integrally formed, thus improving the production efficiency of the housing 100 while improving the overall sealing and shielding effectiveness of the accommodating cavity. The side open to the second bottom wall 130 facilitates installation of the main control circuit board 200 and other internal components of the housing 100. After the main control circuit board 200 is installed on the mounting plane, the second bottom wall 130 is sealingly connected to the side wall 120 to achieve overall sealed connection of the housing 100.

Furthermore, the LiDAR 10 further includes a third conductive adhesive 800. The third conductive adhesive 800 is disposed between the end face of the side wall 120 facing away from the first bottom wall 110 and the second bottom wall 130, and is arranged circumferentially around the LiDAR 10, connected respectively to the second bottom wall 130 and the side wall 120. In this way, the interfering electromagnetic current in the first bottom wall 110 and the side wall 120 can be discharged to ground through the third conductive adhesive 800 via the base; at the same time, the third conductive adhesive 800 also achieves adhesive connection and securement between the side wall 120 and the second bottom wall 130 with good sealing, enabling sufficient electrical conductivity between the side wall 120 and the second bottom wall 130 and improving the electromagnetic protection of the LiDAR 10.

Considering that oxide layers may form on the surfaces of the side wall 120 and the second bottom wall 130, a laser engraving process may be used to remove the oxide layer from the corresponding connection areas of the side wall 120 and the second bottom wall 130, forming an annular first bare metal strip on the side wall 120 and an annular second bare metal strip on the end of the second bottom wall 130 facing the side wall 120, so that the third conductive adhesive 800 connects the first bare metal strip to the second bare metal strip, enhancing the conductivity between the side wall 120 and the second bottom wall 130.

To enhance the sealing between the side wall 120 and the second bottom wall 130, in some embodiments, the end face of the side wall 120 facing away from the first bottom wall 110 is provided with an annular recessed portion 124, and the end of the second bottom wall 130 facing toward the side wall 120 is provided with an annular protruding portion 131. The recessed portion 124 and the protruding portion 131 are located on the outer side of the third conductive adhesive 800, and the protruding portion 131 is embedded in the recessed portion 124. By providing the recessed portion 124 and the protruding portion 131: on one hand, the cooperating structure of the protruding portion 131 embedded in the recessed portion 124 enhances the sealed connection between the side wall 120 and the second bottom wall 130; on the other hand, by disposing the recessed portion 124 and the protruding portion 131 on the outer side of the third conductive adhesive 800, after the side wall 120 and the second bottom wall 130 are connected, the third conductive adhesive 800 is not directly exposed to the outside air, thus improving the service life of the third conductive adhesive 800 and enabling long-term effective maintenance of the conductive connection between the side wall 120 and the second bottom wall 130, thereby improving the overall service life of the LiDAR 10. Furthermore, a sealant is filled between the protruding portion 131 and the recessed portion 124 to improve the sealing between the second bottom wall 130 and the side wall 120. For example, the recessed portion 124 is a groove, the protruding portion 131 is a rib, and the rib is embedded in the groove with sealant filled between the inner wall of the groove and the rib, achieving a sealed connection between the second bottom wall 130 and the side wall 120.

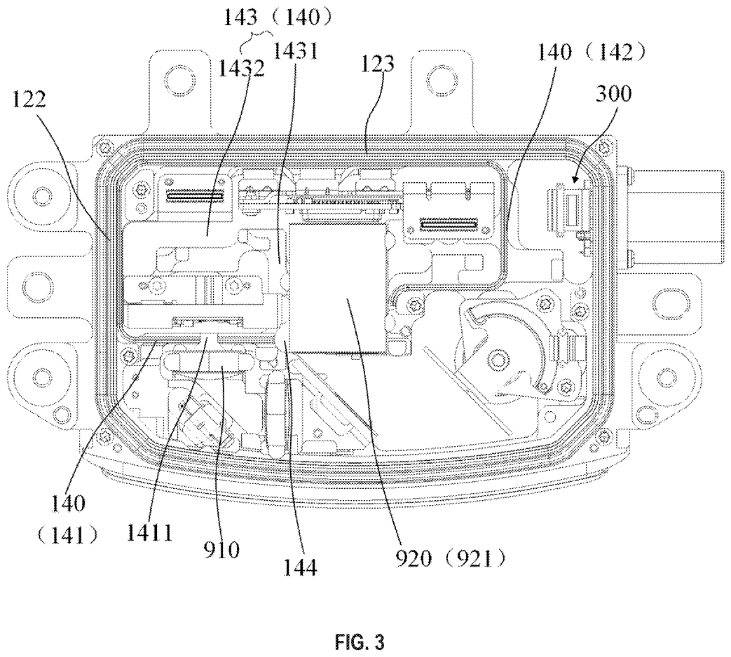

Referring to FIG. 3, in some embodiments, the at least one partition wall 140 includes a plurality of partition walls 140 including a first partition wall 141 and a second partition wall 142. The side wall 120 includes a first wall portion 122 and a second wall portion 123 adjacent to each other in the circumferential direction of the LiDAR 10. One end of the first partition wall 141 is connected to the first wall portion 122 and the other end extends away from the first wall portion 122; one end of the second partition wall 142 is connected to the second wall portion 123 and the other end extends away from the second wall portion 123. The first wall portion 122, the second wall portion 123, the first partition wall 141, and the second partition wall 142 jointly enclose the first cavity 150.

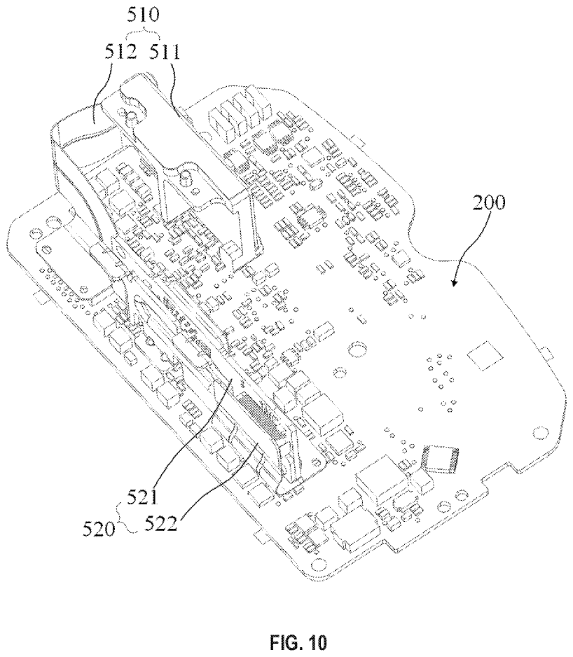

Referring to FIGS. 3, 9, and 10, the transceiver module 500 includes a transmitting module 510 and a receiving module 520. The transmitting module 510 is accommodated in the first cavity 150 and is configured to emit detection light. The transmitting module 510 is disposed opposite the first partition wall 141, and the first partition wall 141 is provided with a first opening 1411 communicating the first cavity 150 with the second cavity 160. The first opening 1411 is configured to allow the detection light to pass therethrough. The receiving module 520 is accommodated in the first cavity 150 and is configured to receive return light and perform photoelectric conversion. A gap exists between the first partition wall 141 and the second partition wall 142 to form a second opening 144 communicating the first cavity 150 with the second cavity 160. The second opening 144 is configured to allow the return light to pass therethrough.

In some embodiments, the transmitting module 510 includes a transmitting board 511 and a third flexible circuit board 512. The third flexible circuit board 512 is connected respectively to the transmitting board 511 and the main control circuit board 200. The transmitting board 511 includes a transmitting substrate and a laser disposed on the transmitting substrate. The laser is configured to generate detection light. Commands sent by the control circuit module 220 are transmitted to the transmitting board 511 through the third flexible circuit board 512 to dynamically adjust the parameters of the detection light generated by the laser. The transmitting substrate is fixedly connected to the first bottom wall 110 or the partition wall 140 by means including but not limited to adhesive bonding, snap-fitting, bolt connection, or screw connection. After the transmitting substrate is fixed, the laser faces directly toward the first opening 1411 to emit the generated detection light out of the first cavity 150 through the first opening 1411. The laser may include a vertical-cavity surface-emitting laser (VCSEL), an edge-emitting laser (EEL), a distributed feedback laser (DFB), a fiber laser, or a similar device.

The receiving module 520 includes a receiving board 521 and a fourth flexible circuit board 522. The fourth flexible circuit board 522 is connected respectively to the receiving board 521 and the main control circuit board 200. The receiving board 521 includes a receiving substrate and a photodetector disposed on the receiving substrate. The photodetector is configured to receive return light and convert optical signals into electrical signals. The receiving substrate is fixedly connected to the first bottom wall 110 or the partition wall 140 by means including but not limited to adhesive bonding, snap-fitting, bolt connection, or screw connection. After the receiving substrate is fixed, the photodetector faces directly toward the second opening 144 to receive return light entering through the second opening 144. The photodetector may include a single-photon avalanche diode (SPAD), an avalanche photodiode (APD), a silicon photomultiplier (SiPM), or a similar device.

It should be noted that the main control circuit board 200 is also provided on the second surface with a clock circuit and a sampling circuit connected to the main controller. The control circuit module 220 includes the main controller and a memory. The clock circuit is configured to generate a clock signal. The sampling circuit is configured to sample the output signal of the receiving board 521 according to the clock signal to obtain a sampled signal. The main controller is configured to invoke a computer program stored in the memory to process the sampled signal to obtain point cloud data. The clock signal provides a high-precision time reference for the LiDAR 10. The difference between the timestamp at which the detection light is generated and the timestamp at which the return light is received is calculated based on the clock signal. Therefore, the fourth flexible circuit board 522 is also configured to transmit the clock signal to feed back the timestamp recorded by the receiving board 521 upon receiving the return light to the main controller.

Considering that high-frequency clock signals have short rise/fall times, resulting in high rates of current change, the fourth flexible circuit board 522 is prone to forming an antenna effect and generating electromagnetic radiation when transmitting the clock signal across the main control circuit board 200 and the receiving board 521. In view of this, in some embodiments, the fourth flexible circuit board 522 is covered on at least the side where signal lines are provided with a shielding film, or the fourth flexible circuit board 522 is sandwiched between two shielding films, and the fourth flexible circuit board 522 is provided with conductive vias electrically connecting the shielding film to the ground wire of the fourth flexible circuit board 522. The shielding film, by wrapping the signal lines used for transmitting the clock signal, forms a closed conductive path that confines the electric field and magnetic field generated by the clock signal within the shielding layer, thus reducing external radiation. The shielding film is connected to the ground wire of the fourth flexible circuit board 522 through the conductive vias, which contain conductive material including but not limited to copper, nickel, or tin. There may be multiple conductive vias uniformly distributed on the fourth flexible circuit board 522 to provide a low-impedance return path, with multi-point grounding forming a grid-like shielding structure that suppresses the antenna effect of high-frequency signals.

In some embodiments, the clock circuit includes a crystal oscillator, a clock generator, and a filter connected in sequence. The filter is configured to perform high-frequency harmonic filtering on the clock signal input to the main controller. The crystal oscillator is the core reference source of the clock circuit, utilizing the piezoelectric effect of quartz crystal to convert mechanical vibrations into stable and high-precision electrical oscillation signals. The clock generator is the core module for processing the clock signal, configured to synthesize, distribute, and optimize the reference frequency input by the crystal oscillator. The filter improves the integrity and reduces the electromagnetic interference of the clock signal input to the main controller by suppressing high-frequency noise and harmonics. The filter includes but is not limited to a ferrite bead, a pi-type LC filter, or a combination thereof.

It will be appreciated that the flexible circuit board has the characteristics of reduced thickness and flexibility, thereby facilitating installation of the transmitting board 511 and the main control circuit board 200 at an angle to each other, and similarly facilitating installation of the receiving board 521 and the main control circuit board 200 at an angle to each other, thereby allowing flexible adjustment of the installation positions of the transmitting board 511 and the receiving board 521.

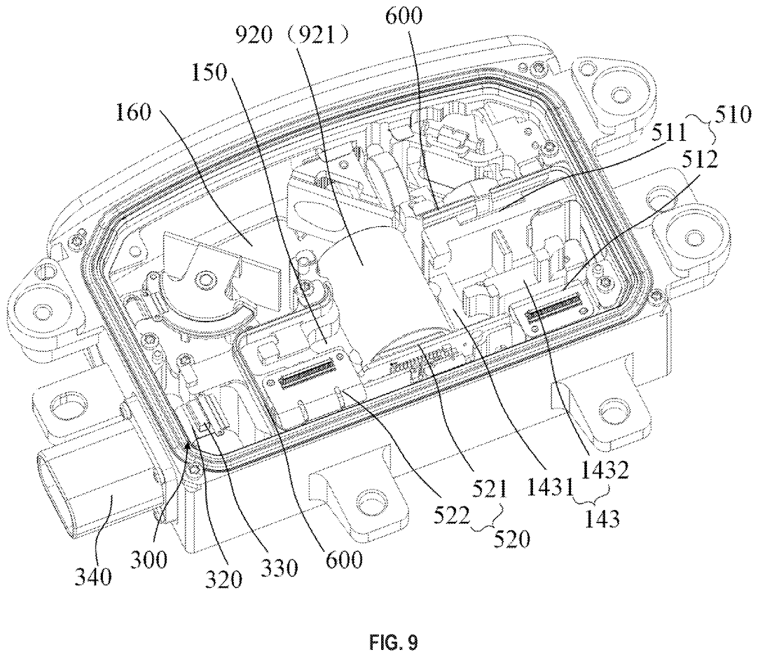

Referring to FIGS. 3 and 9, in some embodiments, the LiDAR 10 further includes a transmitting optical system 910 and a receiving optical system 920. The transmitting optical system 910 is disposed in the second cavity 160 and is configured to receive detection light exiting through the first opening 1411 and to collimate the detection light. The receiving optical system 920 is disposed at the second opening 144 and is configured to receive and converge the return light so that the converged return light is directed toward the receiving module 520.

It should be noted that the transmitting board 511 generates very strong electromagnetic radiation interference when generating detection light. After the receiving board 521 receives the return light, the electrical signals converted from the optical signals are very weak and highly susceptible to external interference. Although both the transmitting board 511 and the receiving board 521 are disposed within the first cavity 150, thereby shielding them from interference signals outside the first cavity 150, the electromagnetic radiation interference generated by the transmitting board 511 can still affect the weak electrical signals on the receiving board 521.

To this end, in some embodiments, the plurality of partition walls 140 further includes a third partition wall 143. The third partition wall 143 is disposed in the first cavity 150 between the transmitting module 510 and the receiving module 520. By providing the third partition wall 143, the transmitting module 510 and the receiving module 520 are isolated and shielded, thus preventing mutual interference between the transmitting board 511 of the transmitting module 510 and the receiving board 521 of the receiving module 520. The transmitting board 511 and the receiving board 521 are designed as independent boards and disposed within the first cavity 150. By separating the transmitting board 511 and the receiving board 521 with the third partition wall 143, on one hand, the interference of the transmitting board 511 on the receiving board 521 and on other circuit parts inside the LiDAR 10 is reduced, thereby reducing the radiated interference of the overall device. On the other hand, the effects of the transmitting board 511, other circuits inside the LiDAR 10, and electromagnetic radiation interference outside the LiDAR 10 on the receiving board 521 are reduced, thereby ensuring the quality of the return signal and improving the performance of the LiDAR 10 in various electromagnetic interference environments.

In some embodiments, the third partition wall 143 includes a first portion 1431 and a second portion 1432. The first portion 1431 is disposed parallel to the optical axis of the receiving optical system 920. The receiving optical system 920 is disposed between the second partition wall 142 and the first portion 1431. One end of the second portion 1432 is connected to the first portion 1431 and the other end extends away from the receiving optical system 920. The second portion 1432 and the first partition wall 141 are disposed on two opposite sides of the transmitting module 510.

In some embodiments, the receiving optical system 920 includes a lens barrel 921 and a receiving lens disposed within the lens barrel 921. The lens barrel 921 is a metal member, or the outer surface of the lens barrel 921 is provided with a metal layer. The lens barrel 921 is connected to and in electrical continuity with both the second partition wall 142 and the first portion 1431 of the third partition wall 143. The lens barrel 921 has electromagnetic shielding properties to prevent electromagnetic interference outside the first cavity 150 from entering the first cavity 150 through the second opening 144. The lens barrel 921 being a metal member includes but is not limited to a copper or aluminum member; the lens barrel 921 may also be an insulating member having a metal layer on its outer surface, the metal layer including but not limited to a copper or aluminum layer, and the insulating member including but not limited to a plastic or ceramic member.

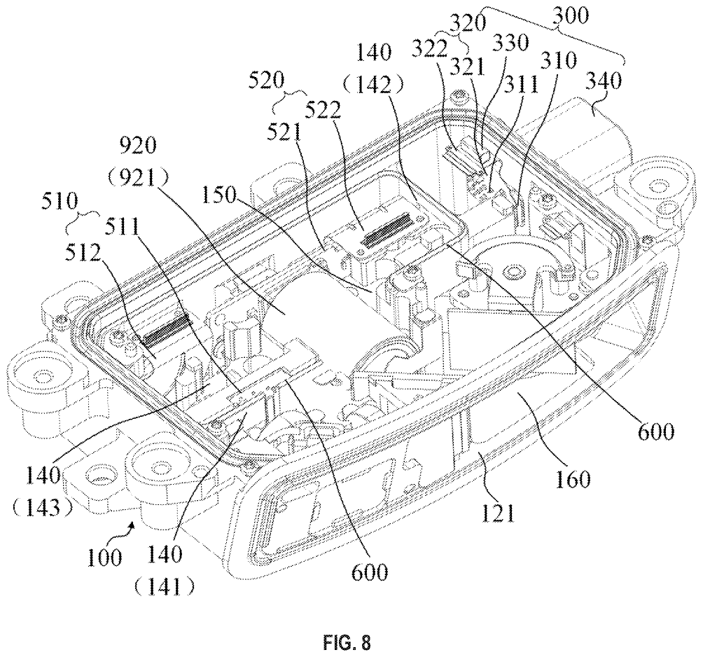

Referring to FIGS. 6 and 8, in some embodiments, the LiDAR 10 further includes an interface board module 300. The interface board module 300 is disposed in the second cavity 160 and includes a substrate 310 and a connector seat 340. The substrate 310 is disposed between the first bottom wall 110 and the main control circuit board 200, and the substrate 310 is connected to the main control circuit board 200. The connector seat 340 is disposed on the side wall 120, connected to the substrate 310, and extends out of the accommodating cavity. An end of the connector seat 340 facing away from the substrate 310 is provided with a power interface and/or a communication interface.

In some embodiments, the interface board module 300 further includes a first flexible circuit board (FPC) 320 and a conductive element 330. The first flexible circuit board 320 has a first end 321 and a second end 322 opposite to each other along an extension direction. The first end 321 of the first flexible circuit board 320 is electrically connected to the plurality of pins 311 of the substrate 310, and the second end 322 is electrically connected to the main control circuit board 200. After the pins 311 on the substrate 310 are connected to external power lines and communication lines, communication between the main control circuit board 200 and external devices can be achieved, as well as the supply of power to the main control circuit board 200 from an external power source. The housing 100 is provided with an installation port, and the connector seat 340 is disposed at the installation port and connected to the housing 100. One end of the connector seat 340 extends into the accommodating cavity and is electrically connected to the plurality of pins 311 on the substrate 310. The power interface and/or communication interface is disposed on the other end of the connector seat 340 that extends outside the housing 100, i.e., the end facing away from the substrate 310.

The present application guides interference signals such as static electricity and electromagnetic noise from the interface board into the housing, thus preventing such interference signals from entering the main control circuit board electrically connected to the interface board, ensuring the integrity of electrical signals on the main control circuit board, and improving the anti-interference performance of the LiDAR. Specifically, by disposing the conductive element 330 at the first grounding window of the first flexible circuit board 320, the conductive element 330 directly electrically connects the ground wire of the first flexible circuit board 320 to the housing 100, thus forming a low-impedance grounding path. External interference signals such as static electricity and electromagnetic noise can be rapidly discharged to the housing 100 through the conductive element 330, thus preventing such interference signals from entering the main control circuit board 200.

In some embodiments, the resistance of the conductive element 330 is less than 1 ohm, so that the conductive element 330 forms a low-impedance path between the first flexible circuit board 320 and the housing 100, and interference signals such as static electricity and electromagnetic noise are preferentially discharged to the housing 100 rather than entering the main control circuit board 200. Specifically, the conductive element 330 may be implemented as conductive adhesive, conductive foam, a conductive spring contact, conductive copper foil, conductive aluminum foil, or conductive graphite.

It should be noted that the larger the loop area formed by signal lines and the ground return path, the stronger the ability to radiate electromagnetic waves externally or receive external interference. When the main control circuit board 200 transmits data signals outward, disposing the conductive element 330 on the first flexible circuit board 320 to electrically connect the housing 100 and the ground wire can shorten the return path of the data signal, reduce the loop area, thereby reducing the electromagnetic radiation generated by the lines on the main control circuit board 200 that transmit data signals outward, and improving the overall electromagnetic compatibility performance of the LiDAR 10.

Furthermore, in some embodiments, the main control circuit board 200 is disposed opposite the second bottom wall 130. The main control circuit board 200 has a first surface facing the first bottom wall 110 and a second surface facing the second bottom wall 130. The second end 322 of the first flexible circuit board 320 is disposed on the second surface, and the conductive element 330 is interposed between the second end 322 of the first flexible circuit board 320 and the second bottom wall 130. The second end 322 of the first flexible circuit board 320 is connected to the main control circuit board 200. The conductive element 330 is disposed between the second end 322 and the second bottom wall 130, and the corresponding first grounding window is provided at the second end 322 of the first flexible circuit board 320. The grounding loop formed between the first flexible circuit board 320 and the housing 100 by the conductive element 330 is closer to the connection between the main control circuit board 200 and the first flexible circuit board 320. When the main control circuit board 200 transmits data signals outward, the return path of the data signal is further shortened, achieving a further reduction in electromagnetic radiation.

For example, after the LiDAR 10 is installed, the first bottom wall 110 is located above the second bottom wall 130, i.e., the second bottom wall 130 serves as the bottom of the LiDAR 10. The downward-facing surface of the main control circuit board 200 is the second surface. With the second end 322 of the first flexible circuit board 320 disposed on the second surface and the conductive element 330 disposed between the second end 322 of the first flexible circuit board 320 and the second bottom wall 130, under the force of gravity, the conductive element 330 can maintain good contact with both the ground wire of the first flexible circuit board 320 and the second bottom wall 130, thereby avoiding grounding failure or impedance increase caused by poor contact.

The first flexible circuit board 320 is provided with a first grounding window, and the conductive element 330 is disposed at the first grounding window to connect with the ground wire of the first flexible circuit board 320, with the conductive element 330 electrically connected to the housing 100. By disposing the conductive element 330 at the first grounding window of the first flexible circuit board 320, the conductive element 330 directly electrically connects the ground wire of the first flexible circuit board 320 to the housing 100, forming a low-impedance grounding path. External interference signals such as static electricity and electromagnetic noise can be rapidly discharged to the housing 100 through the conductive element 330, preventing such interference signals from entering the main control circuit board 200, thereby ensuring the signal quality of the main control circuit board 200 and improving the anti-interference performance of the product.

Furthermore, the second end 322 of the first flexible circuit board 320 is located outside the region surrounded by the second conductive adhesive 700. It will be appreciated that if the second end 322 of the first flexible circuit board 320 were disposed within the region surrounded by the second conductive adhesive 700, the first flexible circuit board 320 would need to pass through the second conductive adhesive 700 in order to extend the first end 321 to connect to the substrate 310, thereby breaking the closed structure of the second conductive adhesive 700 and compromising the overall shielding effect. Accordingly, the second conductive adhesive 700 surrounds the control circuit module 220, primarily to block electromagnetic radiation and noise generated during operation of the control circuit module 220, thereby preventing such interference from affecting other electronic components on the main control circuit board 200 and even components outside the main control circuit board 200. It also blocks external interference signals outside the region surrounded by the second conductive adhesive 700 from entering the region surrounded by the second conductive adhesive 700. By disposing the second end 322 outside the region surrounded by the second conductive adhesive 700, signal crosstalk between the control circuit module 220 and the second end 322 is minimized or avoided, thereby improving the overall electromagnetic compatibility performance of the LiDAR 10.

It will be appreciated that the flexible circuit board has the characteristics of thin thickness and free bendability. Therefore, when the first flexible circuit board 320 electrically connects the main control circuit board 200 to the plurality of pins 311 on the substrate 310, the connection to the main control circuit board 200 and the substrate 310 located on different planes can be achieved by bending the first flexible circuit board 320. In the actual application of the LiDAR 10, this is how the connection between the main control circuit board 200 and an upper-level computer is realized.

In some embodiments, the first end 321 of the first flexible circuit board 320 is located between the first surface of the main control circuit board 200 and the first bottom wall 110, and the main control circuit board 200 is provided with a through-hole 210 through which the first flexible circuit board 320 passes. As described above, to enable the connection of external power lines and communication lines to the pins 311 on the substrate 310, the interface board module 300 also includes a connector. The housing 100 is provided with an installation port for mounting the connector seat 340. The provision of the installation port compromises the shielding performance of the housing 100. By disposing the first end 321 of the first flexible circuit board 320 between the first surface and the first bottom wall 110, the substrate 310 is correspondingly disposed between the first surface and the first bottom wall 110. When the installation port is disposed corresponding to the substrate 310, the installation port connects to the portion of the accommodating cavity located between the first surface and the first bottom wall 110, thus minimizing the impact on the shielding effectiveness of the housing 100 for the electronic components on the second surface. In some embodiments, the electronic components include the control circuit module. The shielding effectiveness of the housing 100 and the main control circuit board 200 itself is relied upon to ensure the integrity of control signals and data signals on the main control circuit board 200.

For example, the substrate 310 and the main control circuit board 200 are spaced apart in the thickness direction of the LiDAR 10, thereby making full use of the vertical space, facilitating the overall miniaturization of the LiDAR 10, and not affecting the flexible layout of the first flexible circuit board 320. In some embodiments, the substrate 310 may be mounted on the side wall 120 with the substrate 310 vertically disposed relative to the main control circuit board 200. The first end 321 of the first flexible circuit board 320 is oriented in the same direction as the substrate 310, and the second end 322 is oriented in the same direction as the main control circuit board 200. The first flexible circuit board 320 further includes a bent section that passes through the through-hole 210, with the two ends of the bent section connected to the first end 321 and the second end 322 respectively. The second end 322 being oriented in the same direction as the main control circuit board 200 means that when the conductive element 330 is disposed between the second end 322 and the second bottom wall 130, the main control circuit board 200 serves as a limiter for the second end 322 and the conductive element 330, thus improving the stability of the connection of the conductive element 330 to both the second bottom wall 130 and the ground wire of the first flexible circuit board 320. In some embodiments, the through-hole 210 is formed at the edge of the main control circuit board 200 through a clearance design, i.e., a step portion is provided at the edge of the main control circuit board 200 near the substrate 310, and the step portion cooperates with the side wall 120 to define a hole through which the first flexible circuit board 320 passes. Compared to providing the through-hole 210 in the interior of the main control circuit board 200, forming the through-hole by edge clearance has less impact on the internal stress distribution of the main control circuit board 200, and also has less impact on the layout of electronic components and circuits on the main control circuit board 200.

Similarly, the provision of the installation port also compromises the shielding performance of the complete housing 100. To prevent interference signals entering through the installation port from affecting the normal operation of the transceiver module 500, in some embodiments, the first end 321 of the first flexible circuit board 320 is disposed in the second cavity 160, i.e., the installation port communicates with the second cavity 160. Therefore, after interference signals enter the second cavity 160 through the installation port, they are also intercepted by the partition wall 140, thus preventing the interference signals from entering the first cavity 150.

In some embodiments, considering that at low temperatures, condensation, frost, or even ice may form on the window cover 400, affecting the normal entry and exit of detection light and return light, the LiDAR 10 is also provided with a heating assembly. The heating assembly is disposed on the window cover 400 and is configured to heat the window cover 400 to remove condensation and the like from the window cover 400 by heating. The heating assembly is electrically connected to the main control circuit board 200, which controls the heating assembly.

Furthermore, to prevent the antenna effect caused by an overly long connection wire between the heating assembly and the main control circuit board 200, which could generate electromagnetic radiation, the connection between the heating assembly and the main control circuit board 200 is made through a combination of a flexible circuit board and a conductive spring contact. In some embodiments, the housing 100 further includes a mounting post disposed in the second cavity 160, with one end of the mounting post fixed to the first bottom wall 110 and the other end extending toward the second bottom wall 130. The LiDAR 10 further includes a second flexible circuit board disposed in the second cavity 160. One end of the second flexible circuit board is electrically connected to the heating assembly, and the other end is provided with a contact terminal. The contact terminal is fixed to the end of the mounting post facing away from the first bottom wall 110. The first surface of the main control circuit board 200 is provided with a conductive spring contact that elastically presses against the contact terminal. When the main control circuit board 200 is installed on the mounting plane, the conductive spring contact on the first surface faces toward the end of the mounting post facing away from the first bottom wall 110 and elastically presses against the contact terminal located on the mounting post, thereby greatly shortening the connection path between the heating assembly and the main control circuit board 200 and reducing the electromagnetic radiation generated during operation of this portion of the conductive path. In some embodiments, the mounting post is disposed near the window 121 to further shorten the extension length of the second flexible circuit board. The contact terminal may be a gold finger at the end of the second flexible circuit board, or may be configured as another connector connected to the lines on the second flexible circuit board; the specific form is not limited.

In the description of the present application, it should be understood that the terms “first,” “second,” and the like are used for descriptive purposes only and should not be understood as indicating or implying relative importance. For those of ordinary skill in the art, the specific meanings of the above terms in this application may be understood in specific situations. In addition, in the description of the present application, unless otherwise stated, “plurality” means two or more. “And/or” describes the associative relationship between associated objects, indicating that three relationships may exist; for example, A and/or B may represent: A exists alone, A and B exist simultaneously, or B exists alone. The character “/” generally indicates an “or” relationship between the objects before and after it.

Unless otherwise defined, all technical and scientific terms used herein have the same meanings as commonly understood by those skilled in the art to which this application belongs. The terms used in the specification of this application are only for describing specific embodiments and are not intended to limit this application. The term “and/or” as used herein includes any and all combinations of one or more of the associated listed items.

The same or similar reference numerals in the drawings of this embodiment correspond to the same or similar components. In the description of this application, it should be understood that if there are terms such as “upper,” “lower,” “left,” “right,” etc. indicating directions or positional relationships, these are based on the directions or positional relationships shown in the drawings, and are only for the convenience of describing this application and simplifying the description, rather than indicating or implying that the device or element referred to must have a specific orientation, be constructed, and operate in a specific orientation. Therefore, the terms describing positional relationships in the drawings are for illustrative purposes only and are not to be construed as limitations on this application. Those of ordinary skill in the art may understand the specific meanings of the above terms in this application according to the specific circumstances.

The foregoing are merely some embodiments of the present application, and are not intended to limit the present application. Any modifications, equivalent replacements, and improvements made within the spirit and principles of the present application shall be included within the scope of protection of the present application.

What is claimed is:

1. A LiDAR, comprising:
a housing comprising a first bottom wall, a side wall, and a second bottom wall arranged sequentially along a thickness direction of the LiDAR, wherein the first bottom wall, the second bottom wall, and the side wall together define an accommodating cavity, and the side wall is provided with a window that communicates the accommodating cavity with an external environment;
a window cover mounted on the housing and covering the window; and
a transceiver module accommodated in the accommodating cavity, configured to emit detection light to detect a target object and to receive return light formed by the detection light reflected from the target object, the detection light and the return light passing into and out of the LiDAR through the window,
wherein the housing further comprises at least one partition wall, one end of the partition wall being fixed to the first bottom wall and the other end extending toward the second bottom wall, the partition wall dividing the accommodating cavity into a first cavity and a second cavity, the transceiver module being disposed in the first cavity, and the second cavity being in communication with the window.

2. The LiDAR of claim 1, wherein the housing is provided with a mounting plane within the accommodating cavity, the mounting plane comprising an end face of the partition wall facing away from the first bottom wall; and
the LiDAR further comprises a main control circuit board fixed between the mounting plane and the second bottom wall.

3. The LiDAR of claim 2, wherein the main control circuit board has a first surface facing the first bottom wall and a second surface facing the second bottom wall;
the LiDAR further comprises a first conductive adhesive disposed on the mounting plane, at least a portion of the first conductive adhesive being disposed on the end face of the partition wall facing away from the first bottom wall, the first conductive adhesive surrounding the first cavity; and
the main control circuit board is provided on the first surface with a first conductive trace corresponding to the first conductive adhesive, the first conductive trace being connected to a ground wire of the main control circuit board, and the first conductive trace being connected to the first conductive adhesive.

4. The LiDAR of claim 3, wherein the main control circuit board is provided on the second surface with a control circuit module and a second conductive trace surrounding the control circuit module, the second conductive trace being connected to the ground wire; and
the LiDAR further comprises a second conductive adhesive disposed between the main control circuit board and the second bottom wall, surrounding the control circuit module, and connected respectively to the second conductive trace and the second bottom wall.

5. The LiDAR of claim 1, wherein the side wall comprises a first wall portion and a second wall portion adjacent to each other in a circumferential direction of the side wall; and
the at least one partition wall comprises a plurality of partition walls including a first partition wall and a second partition wall, one end of the first partition wall being connected to the first wall portion and the other end extending away from the first wall portion, one end of the second partition wall being connected to the second wall portion and the other end extending away from the second wall portion, the first wall portion, the second wall portion, the first partition wall, and the second partition wall jointly enclosing the first cavity.

6. The LiDAR of claim 5, wherein the transceiver module comprises:
a transmitting module accommodated in the first cavity and configured to emit detection light, the transmitting module being disposed opposite the first partition wall, the first partition wall being provided with a first opening communicating the first cavity with the second cavity, the first opening being configured to allow the detection light to pass therethrough; and
a receiving module accommodated in the first cavity and configured to receive the return light and perform photoelectric conversion, a gap existing between the first partition wall and the second partition wall to form a second opening communicating the first cavity with the second cavity, the second opening being configured to allow the return light to pass therethrough.

7. The LiDAR of claim 6, further comprising:
a transmitting optical system disposed in the second cavity and configured to receive detection light exiting through the first opening and to collimate the detection light; and
a receiving optical system disposed at the second opening and configured to receive and converge the return light so that the converged return light is directed toward the receiving module.

8. The LiDAR of claim 7, wherein the plurality of partition walls further comprises a third partition wall, wherein
the third partition wall is disposed in the first cavity between the transmitting module and the receiving module; and
the third partition wall comprises a first portion and a second portion, the first portion being disposed parallel to an optical axis of the receiving optical system, the receiving optical system being disposed between the second partition wall and the first portion, one end of the second portion being connected to the first portion and the other end extending away from the receiving optical system, the second portion and the first partition wall being disposed on two opposite sides of the transmitting module.

9. The LiDAR of claim 8, wherein the receiving optical system comprises:
a lens barrel, the lens barrel being a metal member or having a metal layer on an outer surface thereof; the lens barrel being connected respectively to the second partition wall and the first portion; and
a receiving lens disposed within the lens barrel.

10. The LiDAR of claim 2, further comprising an interface board module disposed in the second cavity and comprising:
a substrate disposed between the first bottom wall and the main control circuit board, the substrate being connected to the main control circuit board; and
a connector seat disposed on the side wall, connected to the substrate, and extending out of the accommodating cavity, an end of the connector seat facing away from the substrate being provided with at least one of a power interface or a communication interface.

11. The LiDAR of claim 1, further comprising a third conductive adhesive disposed between an end face of the side wall facing away from the first bottom wall and the second bottom wall, the third conductive adhesive being arranged circumferentially around the LiDAR, and connected respectively to the second bottom wall and the side wall.

12. The LiDAR of claim 11, wherein an end face of the side wall facing away from the first bottom wall is provided with an annular recessed portion, an end of the second bottom wall facing toward the side wall is provided with an annular protruding portion, the recessed portion and the protruding portion being located on an outer side of the third conductive adhesive, and the protruding portion being embedded in the recessed portion.

13. The LiDAR of claim 1, wherein the first bottom wall, the side wall, and the partition wall are integrally formed.

14. The LiDAR of any one of claim 1, wherein a material of the housing comprises metal.
